(19) United States
(12) Patent Application Publication
(10) Pub. No.: US 2025/0047143 A1
(43) Pub. Date: Feb. 6, 2025

(54) POWER PROFILES FOR ENERGY HARVESTING

(71) Applicant: QUALCOMM Incorporated, San Diego, CA (US)

(72) Inventors: Ahmed Attia ABOTABL, San Diego, CA (US); Ahmed ELSHAFIE, San Diego, CA (US); Alexandros MANOLAKOS, Athens (GR)

(21) Appl. No.: 18/715,458

(22) PCT Filed: Feb. 8, 2023
(86) PCT No.: PCT/US2023/062202

§ 371 Date: May 31, 2024

(30) Foreign Application Priority Data
Feb. 18, 2022 (GR) 20220100150

(51) Int. Cl. H02J 50/80; H02J 50/00; H04W 72/04

(52) U.S. Cl. CPC H02J 50/80; H02J 50/001; H04W 72/04

(57) ABSTRACT

Various aspects of the present disclosure generally relate to wireless communication. In some aspects, a user equipment (UE) may receive an indication of one or more parameters for transmission of an indication of a power profile of the UE. The UE may transmit, based at least in part on the one or more parameters, the indication of the power profile of the UE for configuring a donor device for energy harvesting. Numerous other aspects are described.

### CROSS-REFERENCE TO RELATED APPLICATION

This Patent Application claims priority to Greece Patent Application No. 20220100150, filed on Feb. 18, 2022, entitled “POWER PROFILES FOR ENERGY HARVESTING,” which is hereby expressly incorporated by reference herein.

### FIELD OF THE DISCLOSURE

Aspects of the present disclosure generally relate to wireless communication and to techniques and apparatuses for power profiles for energy harvesting.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving an indication of one or more parameters for transmission of an indication of a power profile of the UE. The method may include transmitting, based at least in part on the one or more parameters, the indication of the power profile of the UE for configuring a donor device for energy harvesting.

Some aspects described herein relate to a method of wireless communication performed by a UE. The method may include receiving an indication of a power profile of an energy harvesting UE and a charging request associated with the energy harvesting UE. The method may include transmitting, based at least in part on the power profile of the energy harvesting UE, energy harvesting signaling to the energy harvesting UE.

Some aspects described herein relate to a UE for wireless communication. The user equipment may include a memory and one or more processors coupled to the memory. The one or more processors may be configured to receive an indication of one or more parameters for transmission of an indication of a power profile of the UE. The one or more processors may be configured to transmit, based at least in part on the one or more parameters, the indication of the power profile of the UE for configuring a donor device for energy harvesting.

Some aspects described herein relate to a UE for wireless communication. The UE may include a memory and one or more processors coupled to the memory. The one or more processors may be configured to receive an indication of a power profile of an energy harvesting UE and a charging request associated with the energy harvesting UE. The one or more processors may be configured to transmit, based at least in part on the power profile of the energy harvesting UE, energy harvesting signaling to the energy harvesting UE.

Some aspects described herein relate to a non-transitory computer-readable medium that stores a set of instructions for wireless communication by a UE. The set of instructions, when executed by one or more processors of the UE, may cause the UE to receive an indication of one or more parameters for transmission of an indication of a power profile of the UE. The set of instructions, when executed by one or more processors of the UE, may cause the UE to transmit, based at least in part on the one or more parameters, the indication of the power profile of the UE for configuring a donor device for energy harvesting.

Some aspects described herein relate to a non-transitory computer-readable medium that stores a set of instructions for wireless communication by a one or more instructions that, when executed by one or more processors of a UE. The set of instructions, when executed by one or more processors of the one or more instructions that, when executed by one or more processors of a UE, may cause the one or more instructions that, when executed by one or more processors of a UE to receive an indication of a power profile of an energy harvesting UE and a charging request associated with the energy harvesting UE. The set of instructions, when executed by one or more processors of the one or more instructions that, when executed by one or more processors of a UE, may cause the one or more instructions that, when executed by one or more processors of a UE to transmit, based at least in part on the power profile of the energy harvesting UE, energy harvesting signaling to the energy harvesting UE.

Some aspects described herein relate to an apparatus for wireless communication. The apparatus may include means for receiving an indication of one or more parameters for transmission of an indication of a power profile of the UE. The apparatus may include means for transmitting, based at least in part on the one or more parameters, the indication of the power profile of the UE for configuring a donor device for energy harvesting.

Some aspects described herein relate to an apparatus for wireless communication. The apparatus may include means for receiving an indication of a power profile of an energy harvesting UE and a charging request associated with the energy harvesting UE. The apparatus may include means for transmitting, based at least in part on the power profile of the energy harvesting UE, energy harvesting signaling to the energy harvesting UE.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of energy harvesting, in accordance with the present disclosure.

FIG. 4 is a diagram illustrating an example associated with a request for energy harvesting (EH) signaling, in accordance with the present disclosure

FIG. 5 is a diagram illustrating an example associated with power profiles for energy harvesting, in accordance with the present disclosure.

FIGS. 6 and 7 are diagrams illustrating example processes associated with power profiles for energy harvesting, in accordance with the present disclosure.

FIGS. 8 and 9 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

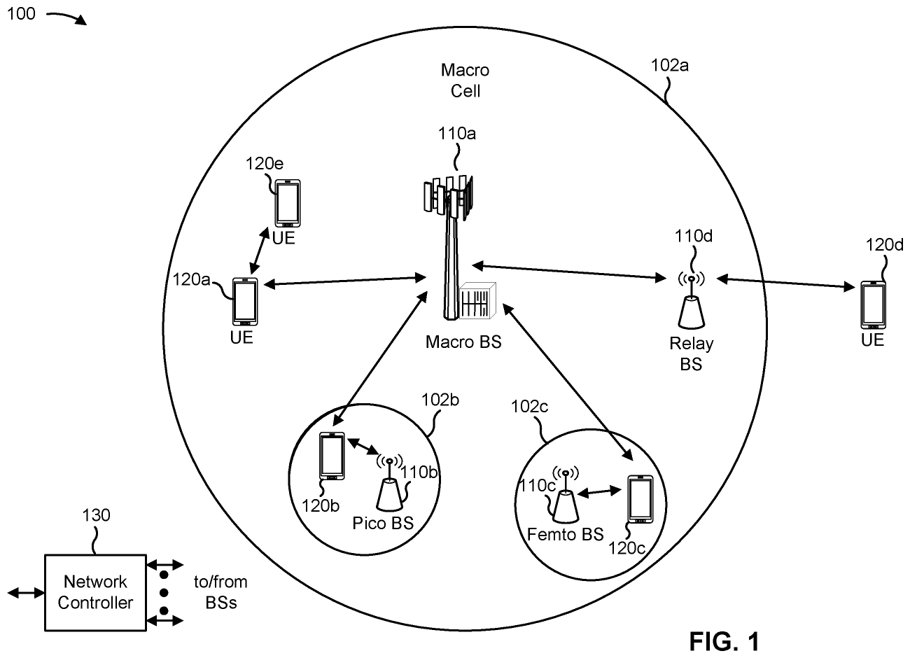

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive an indication of one or more parameters for transmission of an indication of a power profile of the UE; and transmit, based at least in part on the one or more parameters, the indication of the power profile of the UE for configuring a donor device for energy harvesting. Additionally, or alternatively, the communication manager 140 may perform one or more other operations described herein.

In some aspects, the UE 120 may include a communication manager 140. As described in more detail elsewhere herein, the communication manager 140 may receive an indication of a power profile of an energy harvesting UE and a charging request associated with the energy harvesting UE; and transmit, based at least in part on the power profile of the energy harvesting UE, energy harvesting signaling to the energy harvesting UE. Additionally, or alternatively, the communication manager 140 may perform one or more other operations described herein.

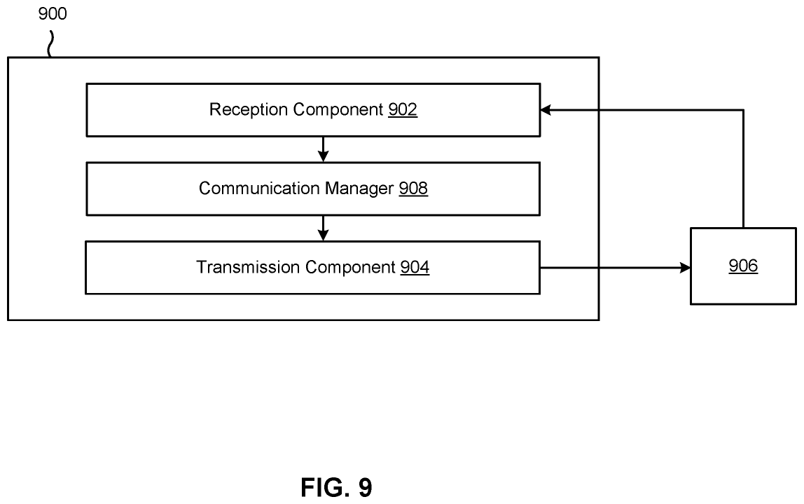

In some aspects, the term “base station” (e.g., the base station 110) or “network node” or “network entity” may refer to an aggregated base station, a disaggregated base station (e.g., described in connection with FIG. 9), an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

As indicated above, FIG. 1 is provided as an example. Other examples may differ from what is described with regard to FIG. 1.

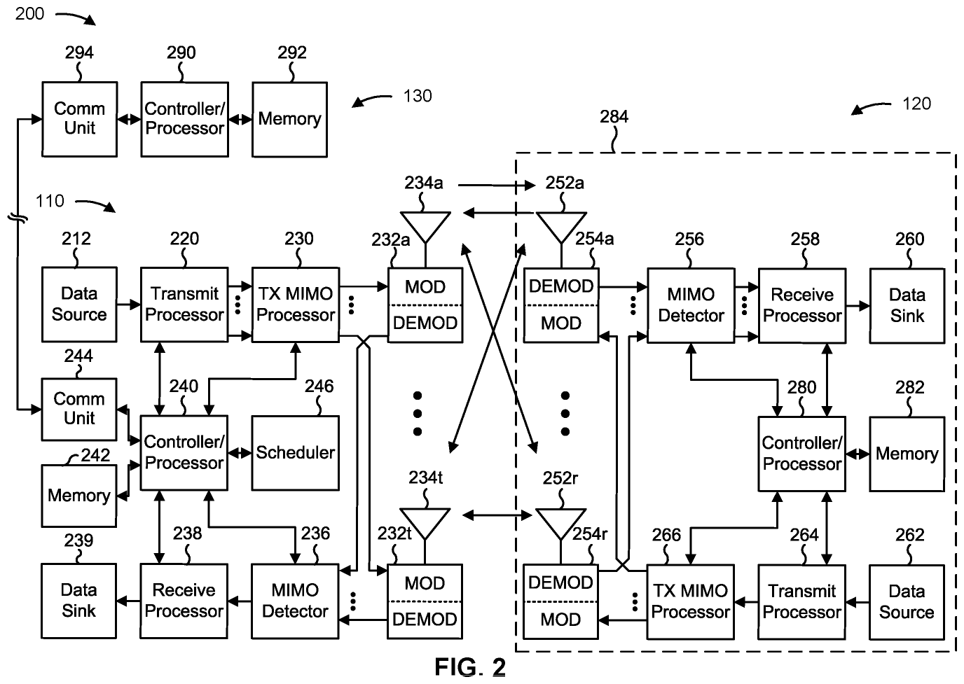

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

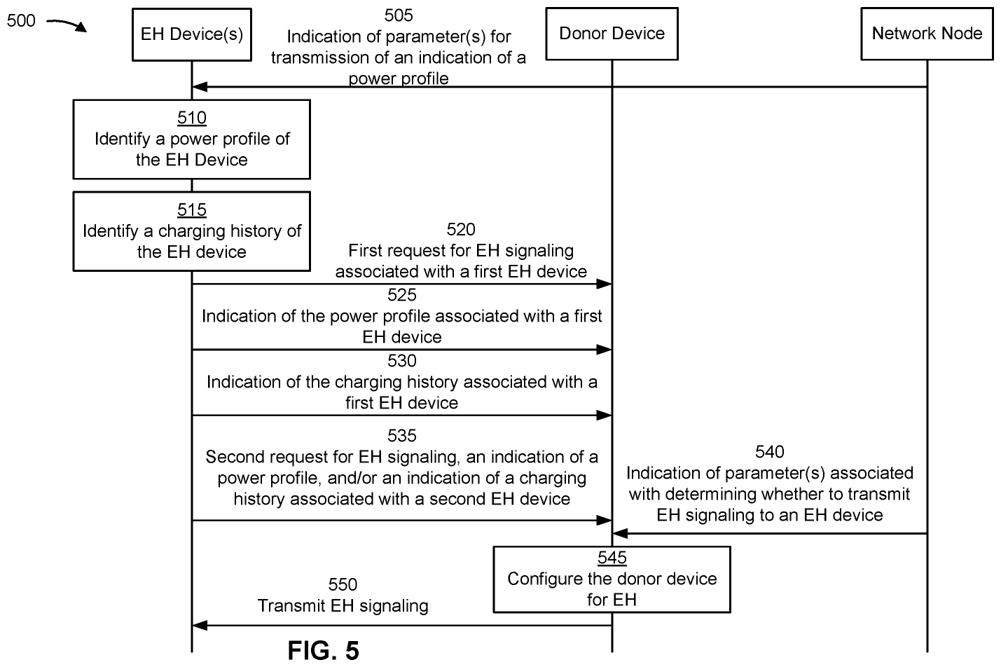

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-9).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-9).

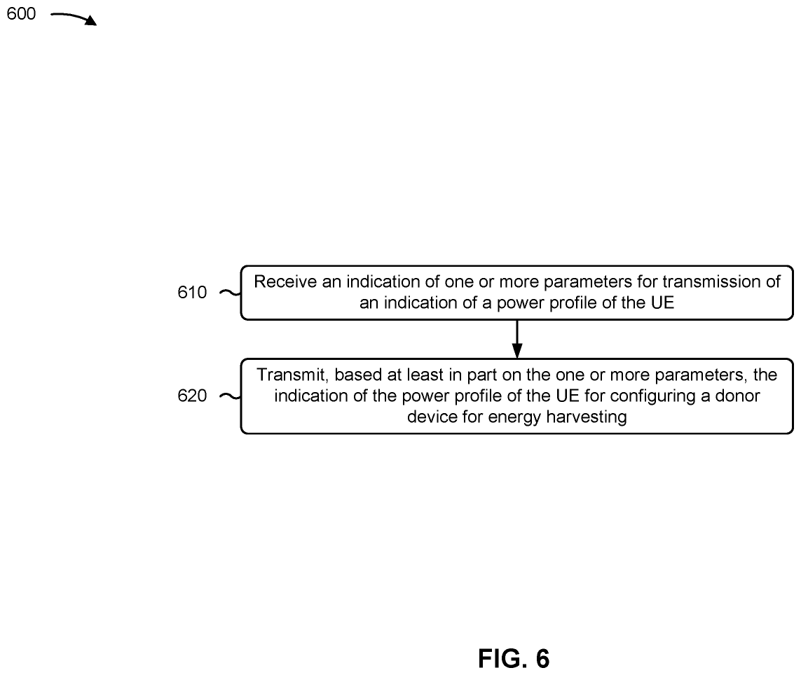

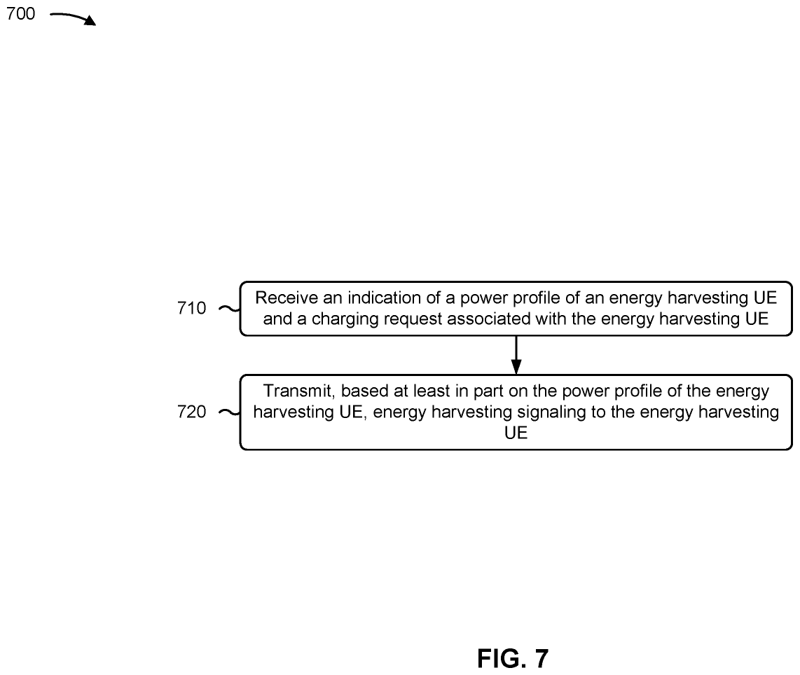

The controller/processor 240 of the base station 110, the controller/processor 280 of the UE 120, and/or any other component(s) of FIG. 2 may perform one or more techniques associated with power profiles for energy harvesting, as described in more detail elsewhere herein. For example, the controller/processor 240 of the base station 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, the UE includes means for receiving an indication of one or more parameters for transmission of an indication of a power profile of the UE; and/or means for transmitting, based at least in part on the one or more parameters, the indication of the power profile of the UE for configuring a donor device for energy harvesting. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE includes means for receiving an indication of a power profile of an energy harvesting UE and a charging request associated with the energy harvesting UE; and/or means for transmitting, based at least in part on the power profile of the energy harvesting UE, energy harvesting signaling to the energy harvesting UE. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

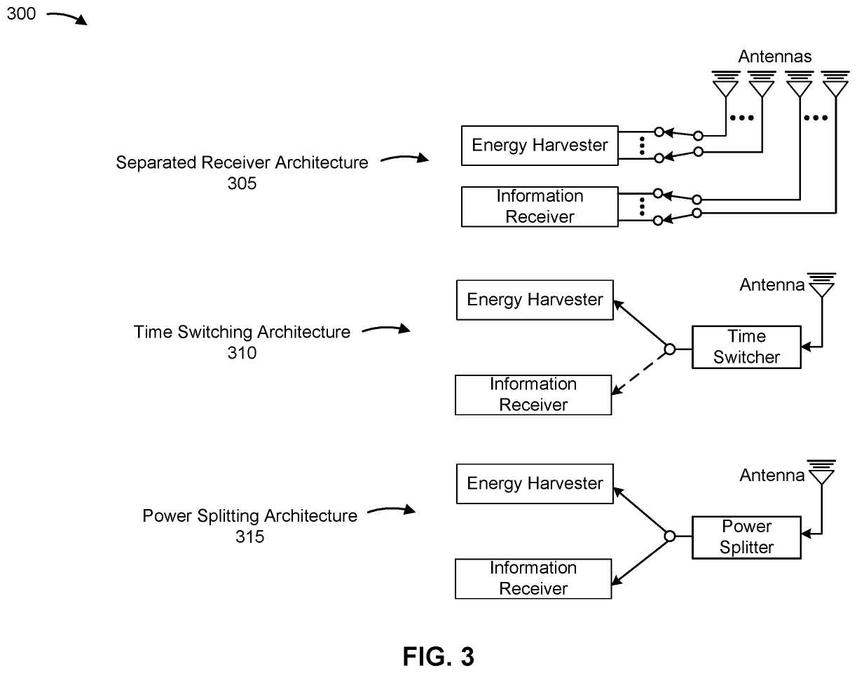

FIG. 3 is a diagram illustrating an example 300 of energy harvesting, in accordance with the present disclosure.

Energy harvesting (EH) includes obtaining energy from a source other than an on-device energy storage device (e.g., a battery or a capacitor, among other examples). EH may be used to supplement energy obtained from an on-device energy storage device and/or may provide charging to the on-device energy storage device. Devices that use EH (“energy harvesting device” or “EH” device”) may have a low-capacity energy storage device (e.g., smart watch) or no energy storage device (e.g., zero power devices, IoT devices, wearables, or financial devices). EH may include converting RF energy transferred from another device. Harvesting RF energy may not provide sufficient energy to fully charge a energy storage device but may be used for performing tasks such as data decoding, operating filters, data reception, data encoding, data reception, and/or data transmission, among other examples. The EH device may accumulate harvested energy over time (e.g., in an on-device energy storage device) to use in a subsequent operation. EH may also be a part of self-sustainable networks, where an EH device in the network may communicate within the network using energy harvested from transmissions of other devices in the network.

As shown in FIG. 3, an EH device (e.g., an RF receiver or a UE 120, among other examples) may receive signals (e.g., radio signals carried on radio waves) from a donor device (e.g., a transmitting device, an RF transmitter, a charging device, a base station 110, or a donor UE 120, among other examples) and convert electromagnetic energy of the signals (e.g., using a rectenna comprising a dipole antenna with an RF diode) into direct current electricity for use by the EH device. The EH device may be a low power device or a zero power device, among other examples.

As shown by reference number 305, in some aspects, the EH device may use a separated receiver architecture, where a first set of antennas is configured to harvest energy, and a second set of antennas is configured to receive data. In this scenario, each set of antennas may be separately configured to receive signals at certain times, frequencies, and/or via one or more particular beams, such that all signals received by the first set of antennas are harvested for energy, and all signals received by the second set of antennas are processed and/or decoded to receive information or other communications.

As shown by reference number 310, in some aspects, the EH device may use a time-switching architecture to harvest energy. The time switching architecture may use one or more antennas to receive signals, and whether the signals are harvested for energy or processed to receive information depends on the time at which the EH device receives the signals. For example, one or more first time slots may be time slots during which received signals are sent to one or more EH components to harvest energy, and one or more second time slots may be time slots during which received signals are processed and decoded to receive information. In some aspects, the time slots may be pre-configured (e.g., by the EH device, the donor device, or another device).

As shown by reference number 315, in some aspects, the EH device may use a power splitting architecture to harvest energy. The power splitting architecture may use one or more antennas to receive signals, and the signals are handled by one or both of the EH and/or information receiving components according to an EH rate. For example, the EH device may be configured to use a first portion of received signals for EH and the remaining received signals for information receiving. In some aspects, the EH rate may be pre-configured (e.g., by the EH device, the donor device, or another device).

The EH device may receive signals for EH on certain resources (e.g., time, frequency, and/or spatial resources) and at a certain power level that results in a particular charging rate. Energy harvested by the EH device may be used and/or stored for later use. For example, in some aspects, the EH device may be powered directly by the harvested energy. In some aspects, the EH device may use an energy storage device, such as a battery, capacitor, and/or supercapacitor, to gather and store harvested energy for immediate and/or later use.

As indicated above, FIG. 3 is provided as an example. Other examples may differ from what is described with regard to FIG. 3.

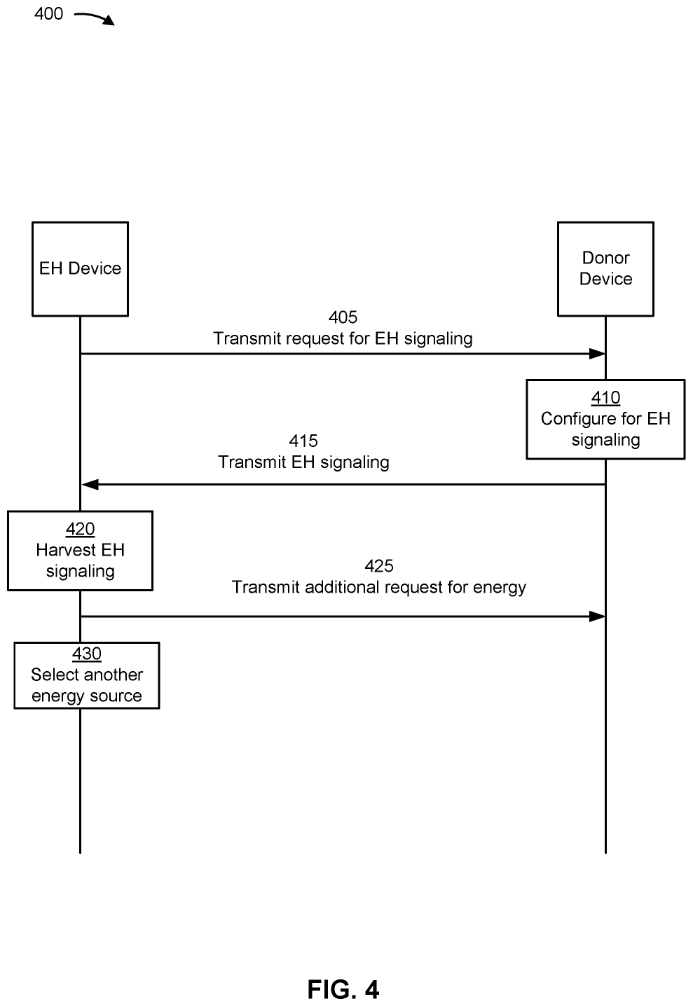

FIG. 4 is a diagram illustrating an example 400 associated with a request for EH signaling, in accordance with the present disclosure. As shown in FIG. 4, an EH device (e.g., IoT, zero power device, a UE 120) may harvest energy from a donor device (e.g., base station 110, UE 120).

As shown by reference number 405, the EH device may transmit a request for energy. The request may include indications of a frequency range for EH signaling, an amount of energy requested, a maximum duration for which the request applies, and/or one or more additional parameters for transmission of the EH signaling.

As shown by reference number 410, the donor device may configure the donor device for EH signaling. For example, the donor device may configure itself for transmitting the EH signaling with one or more parameters to support EH by the EH device. For example, the donor device may configure one or more transmission antenna groups to transmit the EH signaling with a transmission power, a bandwidth, and/or a beam direction to provide the EH signaling to the EH device.

As shown by reference number 415, the donor device may transmit the EH signaling in a direction of the EH device. The EH signaling may be associated with a charging rate. For example, the charging rate may be based at least in part on a frequency of the EH signaling, a bandwidth of the EH signaling, and/or a received power at the EH device, among other examples.

As shown by reference number 420, the EH device may harvest the EH signaling. As described in connection with FIG. 3, the EH device may convert energy from the EH signaling into electrical energy for immediate use and/or may convert energy from the EH signaling into potential energy (e.g., chemical potential energy of the on-board energy storage device) for later use.

As shown by reference number 425, the EH device may transmit an additional request for energy. For example, the EH device may transmit the additional request for energy based at least in part on the EH device failing to harvest a sufficient amount of energy from the EH signaling. The EH device may fail to harvest the sufficient amount of energy based at least in part on the donor device failing to transmit the EH signaling, transmitting the EH signaling with an incorrect configuration, or the EH device consuming energy at a rate that is greater than expected when transmitting the request for EH signaling, or the EH device failing to receive energy from another energy source.

As shown by reference number 430, the EH device may select another energy source. For example, the EH device may select solar energy, vibration harvesting, or kinetic charging to obtain energy from an environment of the EH device.

As indicated above, FIG. 4 is provided as an example. Other examples may differ from what is described with respect to FIG. 4.

In some networks that support EH, a donor device may transmit EH signaling without sufficient information to do so efficiently. For example, the donor device may transmit EH signaling to a first EH device instead of a second EH device with insufficient information to prioritize the first EH device or the second EH device. Additionally, or alternatively, the donor device may transmit EH signaling to an EH device that may not need EH signaling to operate until another EH technology is available. Further, the donor node may determine to refrain from transmitting EH signaling to an EH device based at least in part on an energy state of the donor node without information associated with an urgency of a requesting EH device. In this way, devices of the network intended to support EH may unnecessarily consume power resources and/or may fail to provide needed EH signaling to EH devices.

In some networks, devices may have power profiles that indicate power-based behaviors of the devices. For example, an EH device (e.g., an EH UE) may have a power profile that indicates energy consumption and/or charging of the EH device in an environment. A donor device (e.g., a donor UE) may have a power profile that indicates energy consumption of the donor device and/or energy donation (e.g., via EH signaling).

In some aspects described herein, an EH device may transmit an indication of a power profile of the EH device for use by a donor device to determine whether to transmit EH signaling, how to prioritize EH devices for EH signaling, and/or an amount of charging to provide to the EH device. In some aspects, the EH device may transmit the indication based at least in part on a configuration indicated by a network node (e.g., a base station 110). Each EH device may have unique power profiles that are based at least in part on consumption of energy and/or additional EH sources available (e.g., predicted charging behavior from the additional EH sources), which may be used by a donor device to determine whether to accept one or more requests for EH signaling from the EH devices.

In some aspects, an EH UE may transmit an indication of a power profile of the EH UE. The EH UE may transmit the indication from time to time (e.g., periodically, a-periodically, and/or by request). The indication of the power profile may indicate detailed information about the power profile or a set of metrics associated with the power profile. In some aspects, the EH UE may report the power profile with a level of information that is based at least in part on a configuration (e.g., a radio resource control (RRC) configuration), where each level of information has a corresponding amount of information, periodicity, and/or trigger for reporting.

In some aspects, the indication of the EH UE power profile may include an indication of an average available power at each symbol, slot, frame or a number of frames, among other examples. In some aspects, the indication of the EH UE power profile may include an indication of an average consumed power at each symbol, slot, frame, or a number of frames, among other examples. Additionally, or alternatively, the indication of the EH UE power profile may include an indication of a portion of the EH UE power profile according to available charging technologies (e.g., each one separately). For example, the EH UE power profile may indicate a charging profile of solar EH, which may indicate a predicted charging amount over time (e.g., in terms of hours).

In some aspects, the indication of the EH UE power profile may include an indication of a dominant charging technology per timer. For example, reporting solar or RF EH across one or more previous intervals of time based at least in part on a largest source of EH charging for the EH UE. The EH UE may report the dominant charging technology at intervals of time with a resolution that is configured (e.g., with an RRC configuration), such as intervals of time in minutes or hours. A donor UE may receive the indication of charging histories of EH UEs (e.g., from RF and from other technologies), which the donor UE may use to determine whether to transmit EH signaling. The determination by the donor UE may be based at least in part on a configuration of the donor UE (e.g., an RRC configuration) or a donor UE implementation, among other examples.

In some aspects, an EH UE may track a history of charges from a network node (e.g., a base station), donor UEs, and/or other technologies. The EH UE may indicate (e.g., to the donor UE), an average time it takes from transmission of a request for energy until the request is fulfilled. In some aspects, the EH UE may share the history of a set of recent charging requests and whether the recent charging requests were fulfilled or not. For example, the EH UE may transmit an indication of the history of a set of most recent charging requests and indicate whether each of the charging requests was fulfilled in the form of a bitmap.

In some aspects, a donor UE may be configured (e.g., RRC configured) to determine how to respond to a charging request from other UEs. For example, upon receiving a charging request (e.g., a request for EH signaling) from an EH UE, the donor UE may identify a power profile of the EH UE. Based at least in part on the power profile of the EH UE indicating that power is being consumed at a rate that is faster than a threshold value (e.g., a configured value that is configured by, for example, RRC signaling), the donor UE may determine to deliver the power as fast as possible (e.g., within a time and/or at a rate that is configured by, for example, RRC signaling).

In some aspects, the donor node may use a power profile of the EH UE to determine a discontinuous reception (DRX) cycle (e.g., a DRX-on, DRX cycle durations, and/or other parameters of a configuration of the DRX cycle for the EH UE), a number of DL, UL, or SL transmissions with a DRX-on duration, a time separation between two grants (e.g., UL to DL, DL to UL, DL to DL, UL to UL, SL to SL) such as a periodicity of channel state information reference signals (CSI-RSs), sounding reference signal (SRS), semi-persistent scheduling (SPS), and/or configured grants in sidelink and/or Uu links, and/or an energy status at the EH UE (e.g., based at least in part on charging rate and power profile).

If the donor UE receives two or more charging requests, the donor UE may determine a number of EH UEs to which the donor UE will transmit EH signaling. For example, the donor UE may support transmission of EH signaling to only one EH UE (e.g., in only one direction) or may support transmission of EH signaling to multiple EH UEs. For example, a number of EH UEs to which the donor UE supports transmission of EH signaling may be based at least in part on hardware of the donor UE (e.g., a number of antenna groups, a number of signal generation components, and/or a number of beams that can by simultaneously formed, among other examples), a power profile of the donor UE, and/or a communication status of the donor UE (e.g., engagement in communication with another device and/or engagement in full duplexing, among other examples), among other examples. If the donor UE supports transmission of EH signaling to only one EH UE, the donor UE may select an EH UE with a highest power consumption rate (e.g., with a power level that decreases the fastest). If the donor UE supports transmission of multiple EH UEs, the donor UE may first charge the EH UE with a highest power consumption rate.

Based at least in part on the EH UE transmitting an indication of a power profile of the EH UE, the donor UE may determine whether to transmit the EH signaling to the EH UE and/or how to prioritize requests for EH signaling. In this way, the donor UE may conserve power resources of the donor UE that may have otherwise been used to transmit EH signaling unnecessarily (e.g., when the EH UE is likely to receive EH energy from another source before consuming all power resources of the EH UE) and/or support powering of EH UEs that may otherwise fail to receive EH signaling based at least in part on failing to prioritize requests, among other examples.

FIG. 5 is a diagram of an example 500 associated with power profiles for EH, in accordance with the present disclosure. As shown in FIG. 5, one or more EH devices (e.g., EH UEs) and/or a donor device may communicate with a network node (e.g., a base station and/or an RU). The donor device may be configured to transmit EH signaling and the one or more EH devices may be configured to convert EH signaling into power. In some aspects, the network node, the donor device, and/or the one or more EH devices may be part of a wireless network (e.g., wireless network 100). In some aspects, the donor device may be, or may be included in, the network node. In some aspects, the donor device may communicate with the EH device via a sidelink connection or via a Uu connection. The donor device, the one or more EH devices, and the base station may have established a wireless connection prior to operations shown in FIG. 5.

As shown by reference number 505, the network node may transmit, and the one or more EH devices may receive, an indication of one or more parameters for transmission of an indication of a power profile. For example, the one or more EH devices may receive the indication via configuration information. In some aspects, the one or more EH devices may receive the indication via one or more of RRC signaling, one or more medium access control (MAC) control elements (CEs), and/or downlink control information (DCI), among other examples. In some aspects, the indication may include an indication of one or more configuration parameters (e.g., already known to the one or more EH devices and/or previously indicated by the base station or other network device) for selection by the one or more EH devices, and/or explicit configuration information for the one or more EH devices to use to configure the one or more EH devices, among other examples.

In some aspects, the indication may indicate that the one or more EH devices are to generate indications of power profiles of the one or more EH devices. For example, the indication may indicate what information to include in the indications of the power profiles. In some aspects, the indication of one or more parameters includes a selection of a set of parameters from multiple candidate sets of parameters to include in an indication of a power profile. In some aspects, the indication of one or more parameters includes an indication of information elements to include in the indication of the power profile, a periodicity for transmitting the indication of the power profile, and/or a trigger for transmitting the indication of the power profile.

The one or more EH devices may configure themselves based at least in part on the indication. In some aspects, an EH device may be configured to perform one or more operations described herein based at least in part on the configuration information.

As shown by reference number 510, a first EH device of the one or more EH devices may identify a power profile of the first EH device. For example, the first EH device may identify sources of power, such as RF EH, solar EH, and/or vibration EH for the first EH device. In some aspects, the first EH device may identify a power consumption rate, a power charging rate (e.g., a total power charging rate and/or power charging rates associated with available or predicted sources of power, among other examples), a current power level (e.g., a power state of the first EH device), and/or an expected time until power depletion for the first EH device, among other examples.

As shown by reference number 515, the first EH device may identify a charging history of the first EH device. For example, the first EH device may identify an amount of time between one or more previous requests for EH signaling until receiving the EH signaling and/or a history of one or more previous requests and whether the one or more previous requests were granted (e.g., the first EH device received EH signaling based at least in part on the one or more previous requests).

In some aspects, the charging history may include a history of EH from one or more charging technologies. The first EH may identify a total charging history including one or more charging technologies and/or may identify charging histories independently from the total charging history. For example, the charging history may indicate a history of charging via solar EH, vibration EH, and/or RF EH. The charging history may indicate an amount of charging from the one or more charging technologies (e.g., an amount per unit of time), a reliability of charging from the one or more charging technologies (e.g., how often solar EH generates an amount of power within a threshold amount of an average power from solar EH), and/or timing of the charging from the one or more charging technologies (e.g., a periodicity of charging occasions and/or an amount of time needed to fully charge via the charging technologies, among other examples), among other examples.

As shown by reference number 520, the first EH device may transmit, and the donor device may receive, a first request for EH signaling associated with the first EH device. In some aspects, the first request may indicate a location and/or direction of the first EH device, an amount of charging requested (e.g., a duration of EH signaling), and/or a frequency for the EH signaling, among other examples.

As shown by reference number 525, the first EH device may transmit, and the donor device may receive, an indication of the power profile associated with the first EH device. In some aspects, the first EH device may transmit the indication of the power profile before transmitting the first request for EH signaling, along with the first request for EH signaling, or after transmitting the first request for EH signaling.

In some aspects, the first EH device may transmit the indication of the power profile based at least in part on the one or more parameters indicated by the network node, and/or the first EH device may transmit the indication of the power profile based at least in part on a configuration of the first EH device (e.g., indicated in a communication standard and/or a configuration indicated by a different network node). The indication of the power profile may include a set of parameters from multiple candidate sets of parameters associated with the power profile. In some aspects, the first EH device may transmit the indication of the power profile with a set of one or more information elements associated with the power profile that is based at least in part on a configuration of the first EH device and/or the indication of the one or more parameters indicated by the network node. In some aspects, the first EH device may transmit the indication of the power profile with a periodicity that is based at least in part on a configuration of the first EH device and/or may transmit the indication of the power profile based at least in part on a trigger (e.g., satisfaction of a condition and/or receiving a triggering communication) that is based at least in part on a configuration of the first EH device, among other examples.

In some aspects, the one or more information elements of the indication of the power profile may include an indication of an average available power for one or more time units, an indication of an average consumed power for one or more time units, an EH profile associated with one or more charging technologies supported by the first EH device, and/or an indication of one or more charging technologies used by the first EH device within a threshold amount of time, among other examples.

In some aspects, the donor device (e.g., a donor UE using sidelink transmissions or a donor network node, among other examples) may use the power profile to determine a DRX cycle of the first EH device determined based at least in part on the power profile of the first EH device, a number of uplink, downlink, or sidelink communications during a DRX-on duration determined based at least in part on the power profile of the first EH device, a time separation between resource grants determined based at least in part on the power profile of the first EH device, a periodicity of reference signals, semi-persistent-scheduling communications, or configured grant communications determined based at least in part on the power profile of the first EH device, or an energy status of the first EH device determined based at least in part on the power profile of the first EH device.

As shown by reference number 530, the first EH device may transmit, and the donor device may receive, an indication of the charging history associated with the first EH device. In some aspects, the first EH device may transmit the indication of the charging history of the first EH device before transmitting the first request for EH signaling and/or the indication of the power profile, along with the first request for EH signaling and/or the indication of the power profile, or after transmitting the first request for EH signaling and/or the indication of the power profile. In some aspects, the charging history may include indications of a total charging history, a charging history associated with a subset of charging technologies, and/or a charging history associated with individual charging technologies, among other examples. In some aspects, the charging history indicates a time between transmitting a request for energy and fulfilment of the request and/or whether previous requests for energy were fulfilled or unfulfilled.

As shown by reference number 535, a second EH device may transmit a request for EH signaling, an indication of a power profile of the second EH device, and/or an indication of a charging history associated with the second EH device. In some aspects, the second EH device may transmit the request for EH signaling, the indication of the power profile of the second EH device, and/or the indication of the charging history associated with the second EH device in a single communication or in multiple communications. In some aspects, the second EH device may transmit the request for EH signaling, the indication of the power profile of the second EH device, and/or the indication of the charging history associated with the second EH device before, after, or simultaneously with the first request or the indications described in connection with reference numbers 520, 525, and 530.

As shown by reference number 540, the donor device may receive, and the network node may transmit, an indication of one or more parameters associated with determining whether to transmit EH signaling to an EH device. In some aspects, the one or more parameters may indicate whether to prioritize the first EH device or the second EH device based at least in part on power profiles and/or charging histories of the first EH device and the second EH device. For example, the one or more parameters may be used to determine a priority of the first EH device and the second EH device. In some aspects, the one or more parameters may be used to determine whether the donor device is to consume power resources of the donor device to provide the EH signaling to the first EH device based at least in part on the power profile of the first EH device and/or the power profile of the donor device. For example, if the donor device consumes power at a rate that would deplete power resources of the donor device before a predicting charging opportunity, the donor device may refrain from transmitting the EH signaling.

As shown by reference number 545, the donor device may configure the donor device for EH. For example, the donor device may configure one or more elements of a transmission chain to provide EH signaling in a direction of the first EH device and/or the second EH device. In some aspects, the donor device may configure the donor device for EH based at least in part on the one or more parameters indicated by the network node in connection with reference number 540.

In some aspects, the donor device may configure the donor device for transmitting EH signaling based at least in part on a determination (e.g., based at least in part on the power profile of the first EH device) of a DRX cycle of the EH UE; a number of uplink, downlink, or sidelink communications during a DRX-on duration; a time separation between resource grants; a periodicity of reference signals, semi-persistent-scheduling communications, or configured grant communications; and/or an energy status of the EH UE determined based at least in part on the power profile of the EH UE, among other examples.

As shown by reference number 550, the donor device may transmit, and at least one of the one or more EH devices (e.g., the first EH device and/or the second EH device) may receive, the EH signaling. In some aspects, the donor device may transmit the EH signaling to the first EH device based at least in part on the power profile of the first EH device and/or the power profile of the second EH device. For example, the donor device may transmit the EH signaling to the first EH device based at least in part on the power profile of the first EH device indicating that the EH device consumes power faster than the second EH device and/or that the first EH device will deplete power resources before the second EH device will deplete power resources.

In some aspects, the donor node may transmit the EH signaling to the first EH device based at least in part on the power profile of the first EH device indicating that the first EH device consumes power at a rate that satisfies a threshold. In some aspects, the threshold is associated with a predicted charging occasion and/or a power state of the first EH device (e.g., an amount of stored power). In some aspects, the donor device may transmit the first EH signaling with a charging rate and/or duration that is based at least in part on the power profile of the first EH device.

Based at least in part on the first EH device transmitting an indication of a power profile of the first EH device, the donor device may determine whether to transmit the EH signaling to the first EH device and/or how to prioritize requests for EH signaling. In this way, the donor device may conserve power resources of the donor device that may have otherwise been used to transmit EH signaling unnecessarily (e.g., when the second EH device is likely to receive EH energy from another source before consuming all power resources of the second EH device) and/or support powering of the first EH device that may otherwise fail to receive EH signaling based at least in part on the donor device failing to prioritize requests, among other examples.

As indicated above, FIG. 5 is provided as an example. Other examples may differ from what is described with regard to FIG. 5.

FIG. 6 is a diagram illustrating an example process 600 performed, for example, by a UE, in accordance with the present disclosure. Example process 600 is an example where the UE (e.g., UE 120) performs operations associated with using device power profiles for EH.

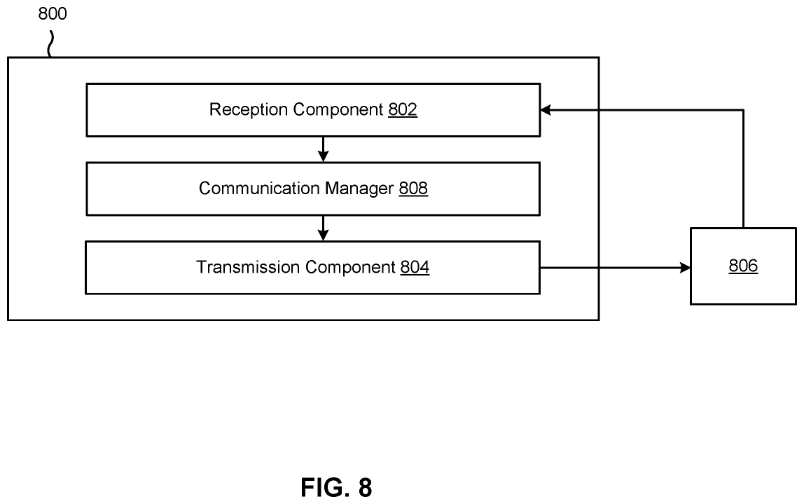

As shown in FIG. 6, in some aspects, process 600 may include receiving an indication of one or more parameters for transmission of an indication of a power profile of the UE (block 610). For example, the UE (e.g., using communication manager 140 and/or reception component 802, depicted in FIG. 8) may receive an indication of one or more parameters for transmission of an indication of a power profile of the UE, as described above.

As further shown in FIG. 6, in some aspects, process 600 may include transmitting, based at least in part on the one or more parameters, the indication of the power profile of the UE for configuring a donor device for EH (block 620). For example, the UE (e.g., using communication manager 140 and/or transmission component 804, depicted in FIG. 8) may transmit, based at least in part on the one or more parameters, the indication of the power profile of the UE for configuring a donor device for EH, as described above.

Process 600 may include additional aspects, such as any single aspect or any combination of aspects described below and/or in connection with one or more other processes described elsewhere herein.

In a first aspect, the indication of one or more parameters comprises a selection of a set of parameters from multiple candidate sets of parameters.

In a second aspect, alone or in combination with the first aspect, the one or more parameters comprise one or more of information elements to include in the indication of the power profile of the UE, a periodicity for transmitting the indication of the power profile of the UE, or a trigger for transmitting the indication of the power profile of the UE.

In a third aspect, alone or in combination with one or more of the first and second aspects, the indication of the power profile comprises one or more of an indication of an average available power for one or more time units, an indication of an average consumed power for one or more time units, an EH profile associated with one or more charging technologies supported by the UE, or an indication of one or more charging technologies used by the UE within a threshold amount of time.

In a fourth aspect, alone or in combination with one or more of the first through third aspects, process 600 includes identifying charging history associated with EH from one or more charging technologies.

In a fifth aspect, alone or in combination with one or more of the first through fourth aspects, process 600 includes transmitting an indication of the charging history.

In a sixth aspect, alone or in combination with one or more of the first through fifth aspects, transmitting the indication of the charging history comprises transmitting an indication of a time between transmitting a request for energy and fulfilment of the request, or transmitting an indication of whether previous requests for energy were fulfilled or unfulfilled.

In a seventh aspect, alone or in combination with one or more of the first through sixth aspects, receiving the indication of the one or more parameters for transmission of the indication of the power profile of the UE comprises receiving the indication of the one or more parameters for transmission of the indication of the power profile of the UE via radio resource control signaling.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a UE, in accordance with the present disclosure. Example process 700 is an example where the UE (e.g., UE 120) performs operations associated with using power profiles for EH.

As shown in FIG. 7, in some aspects, process 700 may include receiving an indication of a power profile of an EH UE and a charging request associated with the EH UE (block 710). For example, the UE (e.g., using communication manager 140 and/or reception component 902, depicted in FIG. 9) may receive an indication of a power profile of an EH UE and a charging request associated with the EH UE, as described above.

As further shown in FIG. 7, in some aspects, process 700 may include transmitting, based at least in part on the power profile of the EH UE, EH signaling to the EH UE (block 720). For example, the UE (e.g., using communication manager 140 and/or transmission component 904, depicted in FIG. 9) may transmit, based at least in part on the power profile of the EH UE, EH signaling to the EH UE, as described above.

Process 700 may include additional aspects, such as any single aspect or any combination of aspects described below and/or in connection with one or more other processes described elsewhere herein.

In a first aspect, process 700 includes receiving, from a network node, an indication of one or more parameters associated with determining whether to transmit the EH signaling to the EH UE.

In a second aspect, alone or in combination with the first aspect, transmitting the EH signaling comprises transmitting the EH signaling based at least in part on one or more of: a DRX cycle of the EH UE determined based at least in part on the power profile of the EH UE, a number of uplink, downlink, or sidelink communications during a DRX-on duration determined based at least in part on the power profile of the EH UE, a time separation between resource grants determined based at least in part on the power profile of the EH UE, a periodicity of reference signals, semi-persistent-scheduling communications, or configured grant communications determined based at least in part on the power profile of the EH UE, or an energy status of the EH UE determined based at least in part on the power profile of the EH UE.

In a third aspect, alone or in combination with one or more of the first and second aspects, transmitting the EH signaling based at least in part on the power profile of the EH UE comprises transmitting the EH signaling based at least in part on the power profile of the EH UE indicating that the EH UE consumes power at a rate that satisfies a threshold.

In a fourth aspect, alone or in combination with one or more of the first through third aspects, transmitting the EH signaling based at least in part on the power profile of the EH UE comprises transmitting the EH signaling with a charging rate that is based at least in part on the power profile of the EH UE.

In a fifth aspect, alone or in combination with one or more of the first through fourth aspects, process 700 includes receiving a first request for the EH signaling for the EH UE, and receiving a second request for EH signaling for an additional EH UE, wherein transmitting the EH signaling to the EH UE is based at least in part on the power profile of the EH UE or a power profile of the additional EH UE.

In a sixth aspect, alone or in combination with one or more of the first through fifth aspects, transmitting the EH signaling based at least in part on the power profile of the EH UE or the power profile of the additional EH UE comprises transmitting the EH signaling to the EH UE based at least in part on the power profile of the EH UE indicating that the EH UE consumes power faster than the additional EH UE.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, an EH device, or EH UE; or a UE, an EH device, or an EH UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include a communication manager 808 (e.g., the communication manager 140).

In some aspects, the apparatus 800 may be configured to perform one or more operations described herein in connection with FIG. 5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The reception component 802 may receive an indication of one or more parameters for transmission of an indication of a power profile of the UE. The transmission component 804 may transmit, based at least in part on the one or more parameters, the indication of the power profile of the UE for configuring a donor device for EH.

The communication manager 808 may identify charging history associated with EH from one or more charging technologies.

The transmission component 804 may transmit an indication of the charging history.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a UE, a donor device, or a donor UE; or a UE, an EH device, or an EH UE may include the apparatus 800. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include a communication manager 908 (e.g., the communication manager 140).

In some aspects, the apparatus 900 may be configured to perform one or more operations described herein in connection with FIG. 5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The reception component 902 may receive an indication of a power profile of an EH UE and a charging request associated with the EH UE. The transmission component 904 may transmit, based at least in part on the power profile of the EH UE, EH signaling to the EH UE.

The reception component 902 may receive, from a network node, an indication of one or more parameters associated with determining whether to transmit the EH signaling to the EH UE.

The reception component 902 may receive a first request for the EH signaling for the EH UE.

The reception component 902 may receive a second request for EH signaling for an additional EH UE wherein transmitting the EH signaling to the EH UE is based at least in part on the power profile of the EH UE or a power profile of the additional EH UE.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: receiving an indication of one or more parameters for transmission of an indication of a power profile of the UE; and transmitting, based at least in part on the one or more parameters, the indication of the power profile of the UE for configuring a donor device for energy harvesting.

Aspect 2: The method of Aspect 1, wherein the indication of one or more parameters comprises a selection of a set of parameters from multiple candidate sets of parameters.

Aspect 3: The method of any of Aspects 1-2, wherein the one or more parameters comprise one or more of: information elements to include in the indication of the power profile of the UE, a periodicity for transmitting the indication of the power profile of the UE, or a trigger for transmitting the indication of the power profile of the UE.

Aspect 4: The method of any of Aspects 1-3, wherein the indication of the power profile comprises one or more of: an indication of an average available power for one or more time units, an indication of an average consumed power for one or more time units, an energy harvesting profile associated with one or more charging technologies supported by the UE, or an indication of one or more charging technologies used by the UE within a threshold amount of time.

Aspect 5: The method of any of Aspects 1-4, further comprising: identifying charging history associated with energy harvesting from one or more charging technologies.

Aspect 6: The method of Aspect 5, further comprising: transmitting an indication of the charging history.

Aspect 7: The method of Aspect 6, wherein transmitting the indication of the charging history comprises: transmitting an indication of a time between transmitting a request for energy and fulfilment of the request, or transmitting an indication of whether previous requests for energy were fulfilled or unfulfilled.

Aspect 8: The method of any of Aspects 1-7, wherein receiving the indication of the one or more parameters for transmission of the indication of the power profile of the UE comprises: receiving the indication of the one or more parameters for transmission of the indication of the power profile of the UE via radio resource control signaling.

Aspect 9: A method of wireless communication performed by a user equipment (UE), comprising: receiving an indication of a power profile of an energy harvesting UE and a charging request associated with the energy harvesting UE; and transmitting, based at least in part on the power profile of the energy harvesting UE, energy harvesting signaling to the energy harvesting UE.

Aspect 10: The method of Aspect 9, further comprising: receiving, from a network node, an indication of one or more parameters associated with determining whether to transmit the energy harvesting signaling to the energy harvesting UE.

Aspect 11: The method of any of Aspects 9-10, wherein transmitting the energy harvesting signaling comprises transmitting the energy harvesting signaling based at least in part on one or more of: a discontinuous reception (DRX) cycle of the energy harvesting UE determined based at least in part on the power profile of the energy harvesting UE, a number of uplink, downlink, or sidelink communications during a DRX-on duration determined based at least in part on the power profile of the energy harvesting UE, a time separation between resource grants determined based at least in part on the power profile of the energy harvesting UE, a periodicity of reference signals, semi-persistent-scheduling communications, or configured grant communications determined based at least in part on the power profile of the energy harvesting UE, or an energy status of the energy harvesting UE determined based at least in part on the power profile of the energy harvesting UE.

Aspect 12: The method of Aspect 11, wherein transmitting the energy harvesting signaling based at least in part on the power profile of the energy harvesting UE comprises: transmitting the energy harvesting signaling based at least in part on the power profile of the energy harvesting UE indicating that the energy harvesting UE consumes power at a rate that satisfies a threshold.

Aspect 13: The method of any of Aspects 11-12, wherein transmitting the energy harvesting signaling based at least in part on the power profile of the energy harvesting UE comprises: transmitting the energy harvesting signaling with a charging rate that is based at least in part on the power profile of the energy harvesting UE.

Aspect 14: The method of any of Aspects 9-13, further comprising: receiving a first request for the energy harvesting signaling for the energy harvesting UE; and receiving a second request for energy harvesting signaling for an additional energy harvesting UE, wherein transmitting the energy harvesting signaling to the energy harvesting UE is based at least in part on the power profile of the energy harvesting UE or a power profile of the additional energy harvesting UE.

Aspect 15: The method of Aspect 14, wherein transmitting the energy harvesting signaling based at least in part on the power profile of the energy harvesting UE or the power profile of the additional energy harvesting UE comprises: transmitting the energy harvesting signaling to the energy harvesting UE based at least in part on the power profile of the energy harvesting UE indicating that the energy harvesting UE consumes power faster than the additional energy harvesting UE.

Aspect 16: An apparatus for wireless communication at a device, comprising a processor; memory coupled with the processor; and instructions stored in the memory and executable by the processor to cause the apparatus to perform the method of one or more of Aspects 1-15.

Aspect 17: A device for wireless communication, comprising a memory and one or more processors coupled to the memory, the one or more processors configured to perform the method of one or more of Aspects 1-15.

Aspect 18: An apparatus for wireless communication, comprising at least one means for performing the method of one or more of Aspects 1-15.

Aspect 19: A non-transitory computer-readable medium storing code for wireless communication, the code comprising instructions executable by a processor to perform the method of one or more of Aspects 1-15.

Aspect 20: A non-transitory computer-readable medium storing a set of instructions for wireless communication, the set of instructions comprising one or more instructions that, when executed by one or more processors of a device, cause the device to perform the method of one or more of Aspects 1-15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive an indication of one or more parameters for transmission of an indication of a power profile of the UE; and
transmit, based at least in part on the one or more parameters, the indication of the power profile of the UE for configuring a donor device for energy harvesting.

2. The UE of claim 1, wherein the indication of one or more parameters comprises a selection of a set of parameters from multiple candidate sets of parameters.

3. The UE of claim 1, wherein the one or more parameters comprise one or more of:
information elements to include in the indication of the power profile of the UE,
a periodicity for transmitting the indication of the power profile of the UE, or
a trigger for transmitting the indication of the power profile of the UE.

4. The UE of claim 1, wherein the indication of the power profile comprises one or more of:
an indication of an average available power for one or more time units,
an indication of an average consumed power for one or more time units,
an energy harvesting profile associated with one or more charging technologies supported by the UE, or
an indication of one or more charging technologies used by the UE within a threshold amount of time.

5. The UE of claim 1, wherein the one or more processors are further configured to:
identify charging history associated with energy harvesting from one or more charging technologies.

6. The UE of claim 5, wherein the one or more processors are further configured to:
transmit an indication of the charging history.

7. The UE of claim 6, wherein the one or more processors, to transmit the indication of the charging history, are configured to:
transmit an indication of a time between transmitting a request for energy and fulfilment of the request, or
transmit an indication of whether previous requests for energy were fulfilled or unfulfilled.

8. The UE of claim 1, wherein the one or more processors, to receive the indication of the one or more parameters for transmission of the indication of the power profile of the UE, are configured to:
receive the indication of the one or more parameters for transmission of the indication of the power profile of the UE via radio resource control signaling.

9. A user equipment (UE) for wireless communication, comprising:
a memory; and
one or more processors, coupled to the memory, configured to:
receive an indication of a power profile of an energy harvesting UE and a charging request associated with the energy harvesting UE; and
transmit, based at least in part on the power profile of the energy harvesting UE, energy harvesting signaling to the energy harvesting UE.

10. The UE of claim 9, wherein the one or more processors are further configured to:
receive, from a network node, an indication of one or more parameters associated with determining whether to transmit the energy harvesting signaling to the energy harvesting UE.

11. The UE of claim 9, wherein the one or more processors, to transmit the energy harvesting signaling, are configured to transmit the energy harvesting signaling based at least in part on one or more of:
a discontinuous reception (DRX) cycle of the energy harvesting UE determined based at least in part on the power profile of the energy harvesting UE,
a number of uplink, downlink, or sidelink communications during a DRX-on duration determined based at least in part on the power profile of the energy harvesting UE,
a time separation between resource grants determined based at least in part on the power profile of the energy harvesting UE,
a periodicity of reference signals, semi-persistent-scheduling communications, or configured grant communications determined based at least in part on the power profile of the energy harvesting UE, or
an energy status of the energy harvesting UE determined based at least in part on the power profile of the energy harvesting UE.

12. The UE of claim 11, wherein the one or more processors, to transmit the energy harvesting signaling, are configured to:
transmit the energy harvesting signaling based at least in part on the power profile of the energy harvesting UE indicating that the energy harvesting UE consumes power at a rate that satisfies a threshold.

13. The UE of claim 11, wherein the one or more processors, to transmit the energy harvesting signaling, are configured to:
transmit the energy harvesting signaling with a charging rate that is based at least in part on the power profile of the energy harvesting UE.

14. The UE of claim 9, wherein the one or more processors are further configured to:
receive a first request for the energy harvesting signaling for the energy harvesting UE; and
receive a second request for energy harvesting signaling for an additional energy harvesting UE,
wherein transmitting the energy harvesting signaling to the energy harvesting UE is based at least in part on the power profile of the energy harvesting UE or a power profile of the additional energy harvesting UE.

15. The UE of claim 14, wherein the one or more processors, to transmit the energy harvesting signaling, are configured to:
transmit the energy harvesting signaling to the energy harvesting UE based at least in part on the power profile of the energy harvesting UE indicating that the energy harvesting UE consumes power faster than the additional energy harvesting UE.

16. A method of wireless communication performed by a user equipment (UE), comprising:
receiving an indication of one or more parameters for transmission of an indication of a power profile of the UE; and
transmitting, based at least in part on the one or more parameters, the indication of the power profile of the UE for configuring a donor device for energy harvesting.

17. The method of claim 16, wherein the indication of one or more parameters comprises a selection of a set of parameters from multiple candidate sets of parameters.

18. The method of claim 16, wherein the one or more parameters comprise one or more of:
information elements to include in the indication of the power profile of the UE,
a periodicity for transmitting the indication of the power profile of the UE, or
a trigger for transmitting the indication of the power profile of the UE.

19. The method of claim 16, wherein the indication of the power profile comprises one or more of:
an indication of an average available power for one or more time units,
an indication of an average consumed power for one or more time units,
an energy harvesting profile associated with one or more charging technologies supported by the UE, or
an indication of one or more charging technologies used by the UE within a threshold amount of time.

20. The method of claim 16, further comprising:
identifying charging history associated with energy harvesting from one or more charging technologies.

21. The method of claim 20, further comprising:
transmitting an indication of the charging history.

22. The method of claim 21, wherein transmitting the indication of the charging history comprises:
transmitting an indication of a time between transmitting a request for energy and fulfilment of the request, or
transmitting an indication of whether previous requests for energy were fulfilled or unfulfilled.

23. The method of claim 16, wherein receiving the indication of the one or more parameters for transmission of the indication of the power profile of the UE comprises:
receiving the indication of the one or more parameters for transmission of the indication of the power profile of the UE via radio resource control signaling.

24. A method of wireless communication performed by a user equipment (UE), comprising:
receiving an indication of a power profile of an energy harvesting UE and a charging request associated with the energy harvesting UE; and
transmitting, based at least in part on the power profile of the energy harvesting UE, energy harvesting signaling to the energy harvesting UE.

25. The method of claim 24, further comprising:
receiving, from a network node, an indication of one or more parameters associated with determining whether to transmit the energy harvesting signaling to the energy harvesting UE.

26. The method of claim 24, wherein transmitting the energy harvesting signaling comprises transmitting the energy harvesting signaling based at least in part on one or more of:
a discontinuous reception (DRX) cycle of the energy harvesting UE determined based at least in part on the power profile of the energy harvesting UE,
a number of uplink, downlink, or sidelink communications during a DRX-on duration determined based at least in part on the power profile of the energy harvesting UE,
a time separation between resource grants determined based at least in part on the power profile of the energy harvesting UE,
a periodicity of reference signals, semi-persistent-scheduling communications, or configured grant communications determined based at least in part on the power profile of the energy harvesting UE, or
an energy status of the energy harvesting UE determined based at least in part on the power profile of the energy harvesting UE.

27. The method of claim 26, wherein transmitting the energy harvesting signaling based at least in part on the power profile of the energy harvesting UE comprises:
transmitting the energy harvesting signaling based at least in part on the power profile of the energy harvesting UE indicating that the energy harvesting UE consumes power at a rate that satisfies a threshold.

28. The method of claim 26, wherein transmitting the energy harvesting signaling based at least in part on the power profile of the energy harvesting UE comprises:
transmitting the energy harvesting signaling with a charging rate that is based at least in part on the power profile of the energy harvesting UE.

29. The method of claim 24, further comprising:
receiving a first request for the energy harvesting signaling for the energy harvesting UE; and
receiving a second request for energy harvesting signaling for an additional energy harvesting UE,
wherein transmitting the energy harvesting signaling to the energy harvesting UE is based at least in part on the power profile of the energy harvesting UE or a power profile of the additional energy harvesting UE.

30. The method of claim 29, wherein transmitting the energy harvesting signaling based at least in part on the power profile of the energy harvesting UE or the power profile of the additional energy harvesting UE comprises:
transmitting the energy harvesting signaling to the energy harvesting UE based at least in part on the power profile of the energy harvesting UE indicating that the energy harvesting UE consumes power faster than the additional energy harvesting UE.
